(19) United States
(12) Patent Application Publication
(10) Pub. No.: US 2013/0211952 A1
(43) Pub. Date: Aug. 15, 2013

(54) BUSINESS SALES PROMOTION SERVER, BUSINESS SALES PROMOTION METHOD, AND BUSINESS SALES PROMOTION PROGRAM

(71) Applicant: Shunji SUGAYA, Tokyo (JP)

(72) Inventor: Shunji SUGAYA, Tokyo (JP)

(73) Assignee: OPTIM CORPORATION, Saga (JP)

(21) Appl. No.: 13/450,015

(22) Filed: Apr. 18, 2012

(30) Foreign Application Priority Data
Feb. 15, 2012 (JP) 2012-031184

(51) Int. Cl. G06Q 30/06

(52) U.S. Cl. CPC G06Q 30/0631
USPC 705/26.7

(57) ABSTRACT

A business sales promotion server analyzes information on the type of electric appliance connected with a network in order to recommend a sales representative to sell electric appliances. The business sales promotion server stores electric appliance configuration in relation to a local network, the electric appliance configuration including model related information acquired from an electric appliance communicatively connected with the local network, outputs information on an electric appliance being lacking in one local network to the sales representative terminal based on the electric appliance configuration, and then recommends the sale of the electric appliance.

### CROSS REFERENCE TO RELATED APPLICATION

This application is based on and claims the benefit of priority from Japanese Patent Application No. 2012-031184, filed on Feb. 15, 2012, the content and teachings of which are incorporated herein by reference.

### TECHNICAL FIELD

The invention relates to a business sales promotion server, a business sales promotion method, and a business sales promotion program that promote business sales based on information on a device connected with a network.

### BACKGROUND ART

Recently, a method or device has been known in which a device such as a router or gateway automatically identifies the type of an electric appliance connected with a home or office network.

For example, PLT 1 discloses that an information processing unit sends and receives network protocols to and from an electric appliance conducts scoring based on response packets specific to the electric appliance to identify the type of the electric appliance.

On the other hand, technology to support the company's operations has been known using the information processing technology. For example, PLT 2 discloses a method of promoting business sales by using a questionnaire or the like through media such as not only direct mail but also e-mail and a browser.

### CITATION LIST

### Patent Literature

PLT 1: Japanese Unexamined Patent Application 2010-097587

PLT 2: Japanese Unexamined Patent Application 2002-041681

### SUMMARY OF INVENTION

However, the method described in PLT 2 cannot use information on the type of the electric appliance identified by the method described in PLT 1 for sales promotion. In fact, information on the electric appliance that has already been connected with a local network at home, office, or the like can be a criterion to determine whether or not a new electric appliance should be purchased for this local network. For example, it is highly possible that a user of the local network with which an old type of electric appliance is connected purchases the newer type recommended for replacement.

Accordingly, the inventors have focused attention on supporting the sales activity of business representatives for an electric appliance sales company with a system assessing information on the type of the user's electric appliance.

An objective of the present invention is to provide a business sales promotion server, a business sales promotion method, and a business sales promotion program that are capable of analyzing information on the type of electric appliance connected with each network to support business representatives to sell electric appliances.

According to one embodiment, a business sales promotion server communicatively connected with a sales representative terminal includes: an electric appliance configuration storage module configured to store electric appliance configuration in relation to a local network, the electric appliance configuration including model related information acquired from an electric appliance connected with the local network; and a recommendation module configured to output information on an electric appliance being lacking in one local network to the sales representative terminal based on the electric appliance configuration and then to recommend the sale of the electric appliance.

According to this embodiment, the business sales promotion server stores electric appliance configuration in relation to a local network, the electric appliance configuration including model related information acquired from an electric appliance communicatively connected with the local network, outputs information on an electric appliance being lacking in one local network to the sales representative terminal based on the electric appliance configuration, and then recommends the sale of the electric appliance.

Accordingly, the business sales promotion server can recommend a sales representative to sell the predetermined electric appliance based on the configuration of an electric appliance connected with each network so as to support their sales activity.

According to one embodiment, the business sales promotion server further includes a trend analysis module configured to analyze the average configuration ratio of one electric appliance to another electric appliance based on the electric appliance configuration, in which the recommendation module recommends the sale of an electric appliance and the unit sales thereof based on the configuration ratio analyzed by the trend analysis module.

According to one embodiment, the recommendation module recommends the sale of an electric appliance based on a sales order predetermining an electric appliance to be sold and the number thereof.

According to one embodiment, the business sales promotion server further includes a correction module configured to correct the recommendation from the recommendation module based on feedback data input from the sales representative terminal.

According to the present invention, the business sales promotion server can recommend a sales representative to sell the predetermined electric appliance based on the configuration of an electric appliance connected with each network so as to support their sales activity.

### BRIEF DESCRIPTION OF DRAWINGS

FIG. 1 shows an overall schematic diagram of an example recommendation processing system.

FIG. 2 shows a functional block diagram of an example information processing unit and an example business sales promotion server.

FIG. 3 shows a flow chart illustrating an example model related information determination process executed by an example information processing unit and an example electric appliance.

FIG. 4 shows a flow chart illustrating an example sales recommendation process executed by an example business sales promotion server.

FIG. 5 shows an example electric appliance configuration table stored in an example business sales promotion server.

FIG. 6 shows an example company size table stored in an example business sales promotion server.

FIG. 7 shows an example trend analysis table stored in an example business sales promotion server.

FIG. 8 shows another example electric appliance configuration table stored in an example business sales promotion server.

FIG. 9 shows an example recommendation result table stored in an example business sales promotion server.

FIG. 10 is an example screen image of the electric appliance list screen displayed on an example sales representative terminal.

FIG. 11 is an example screen image of the recommended electric appliance for sales screen displayed on an example sales representative terminal.

FIG. 12 is an example screen image of the sales performance input screen displayed on an example sales representative terminal.

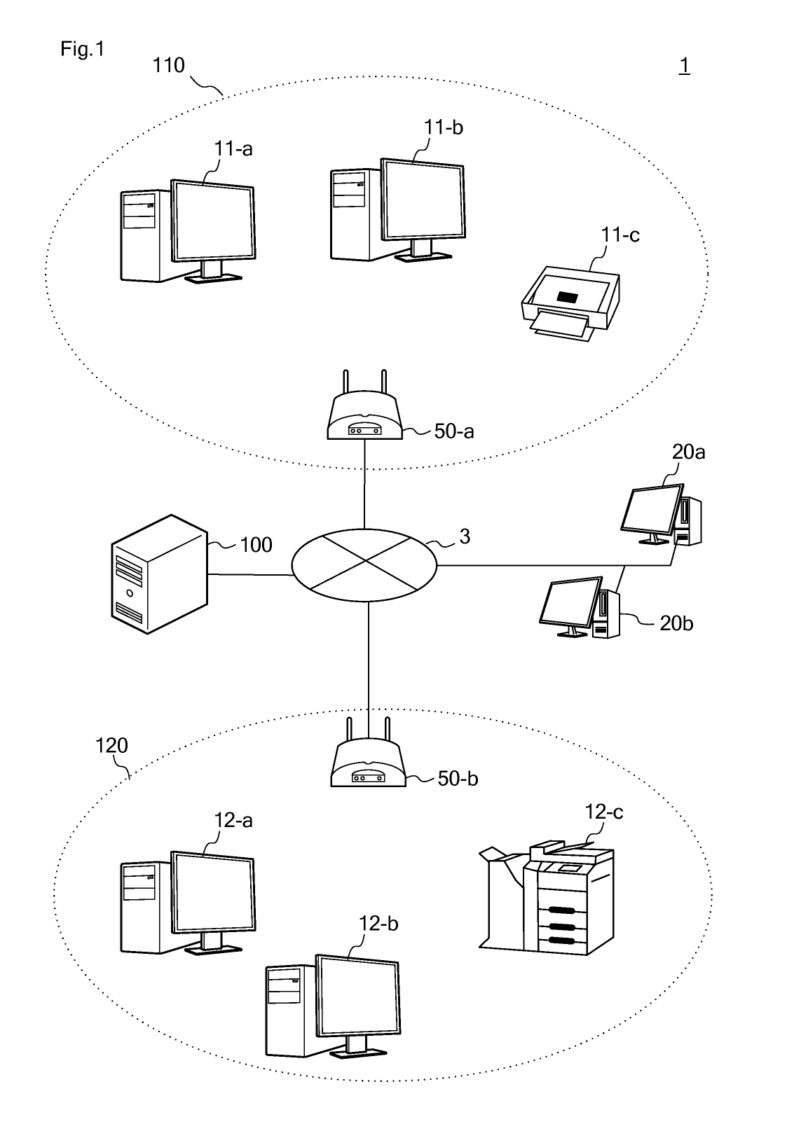

### DESCRIPTION OF EMBODIMENTS

Hereinafter, embodiments of the present invention will be described with reference to the attached drawings. However, this is illustrative only, and the technological scope of the present invention is not limited thereto.

### Configuration of Recommendation Processing System

The recommendation processing system 1 is a network system in which a business sales promotion server 100, sales representative terminals 20a and 20b (hereinafter referred to as “20”), and local systems 110 and 120 are connected with a public network 3 such as the Internet. The local systems 110 and 120 include information processing units 50-a and 50-b (hereinafter referred to as “50”) respectively and form respective local area networks (hereinafter referred to as “LAN”). In the local system 110, the information processing unit 50-a and electric appliances 11-a, 11-b, and 11-c (hereafter referred to as “11”) are communicatively connected. In the local system 120, the information processing unit 50-b and electric appliances 12-a, 12-b, and 12-c (hereafter referred to as “12”) are communicatively connected.

The local systems 110 and 120 are local area network systems owned by a company, home, organization, or the like. The communication within each local system is controlled by private IP addresses. For example, the local system 110 is owned by the company A while the local system 120 is owned by the company B. Accordingly, the electric appliance 11 belonging to the local system 110 and the electric appliance 12 belonging to the local system 120 cannot be communicated without special authentication processing for security reasons.

The local systems may be distinguished by a LAN or SSID. Specifically, one local system may be configured by electric appliances 11 connected to one SSID.

The information processing unit 50 may be a device performing a general computer processing, such as a local server, a network device such as a router or gateway, or a mobile phone such as a smart phone. The information processing unit 50 may also be a complex printer, a television, or a home electric appliance such as a refrigerator or a washing machine. The information processing unit 50 may also be a general information appliance such as a telephone, a netbook terminal, a slate terminal, an electronic book terminal, an electronic dictionary terminal, a portable music player, or a portable player capable of recording and playing back contents.

The electric appliance 11 is a home or office electric appliance capable of data communication. The electric appliance 11 includes information appliances such as personal computers 11-a and 11-b, a television, a telephone, a computer, a mobile phone, a handheld terminal, a net book terminal, a tablet terminal, a slate terminal, an electronic book terminal, a portable music player, an audio component, a player capable of recording and playing back contents, a printer 11-c, a facsimile machine, a copy machine, a scanner machine, and a multi-function peripheral device, or a multi-function printer (hereinafter referred to as “MFP”). The electric appliance 11 also includes home electric appliances such as a refrigerator, a washing machine, a dishwasher, a fan, an air conditioner, an electric stove, a rice cooker, and a microwave oven. The electric appliance 11 also includes a light, a server, routers 50-a and 50-b, a gateway, a network attached storage (hereinafter referred to as “NAS”), and a projector.

### Functions

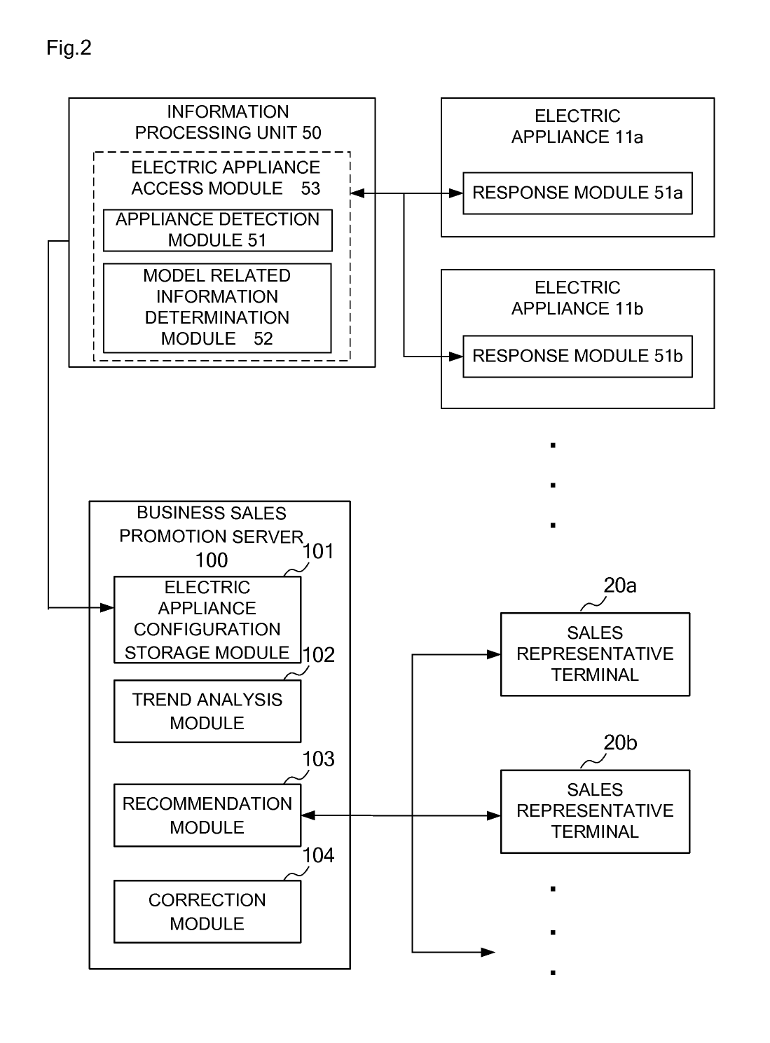

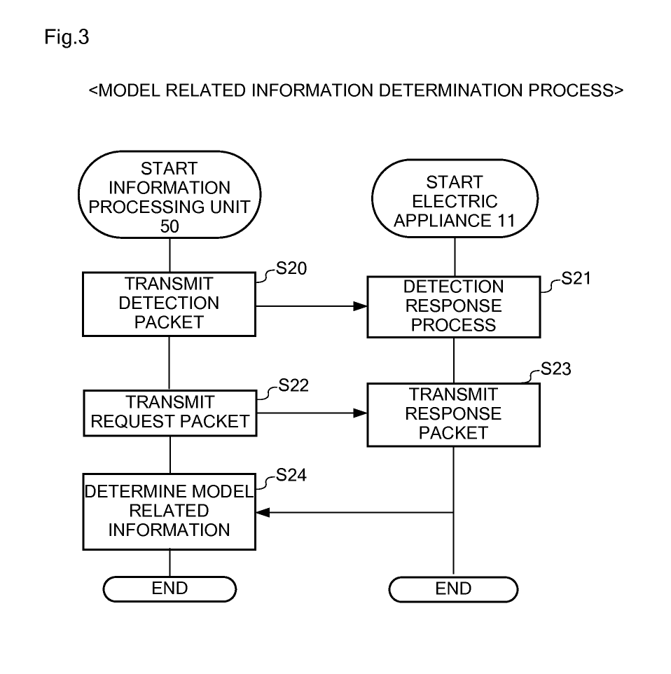

FIG. 2 shows a functional block diagram of the information processing unit 50 and the business sales promotion server 100, illustrating these functional relationships.

The business sales promotion server 100 includes a control unit provided with a central processing unit (hereinafter referred to as “CPU”), random access memory (hereinafter referred to as “RAM”), and read only memory (hereinafter referred to as “ROM”). The business sales promotion server 100 also includes a communication unit such as Wireless Fidelity® or WiFi® enabled device complying with, for example, IEEE 802.11, or a wireless device complying with the IMT-2000 standard such as a third or fourth generation mobile communication system. The communication unit may be achieved through fixed LAN connection. The business sales promotion server 100 also includes a data storage unit as a memory unit such as a hard disk or semiconductor memory to store data.

The memory unit of the business sales promotion server 100 at least stores an electric appliance configuration table, a company size table, a trend analysis table, an electric appliance configuration table 2, and a recommendation result table, as described hereinafter.

In the business sales promotion server 100, the control unit reads a predetermined program to cooperate with the communication unit and the memory unit to achieve an electric appliance configuration storage module 101, a trend analysis module 102, a recommendation module 103, and a correction module 104.

Similarly to the business sales promotion server 100, the sales representative terminal 20 includes a control unit, a memory unit, and a communication unit. The sales representative terminal 20 also includes an output unit, such as a display unit, to output and display data and images that are controlled by the control unit. The sales representative terminal 20 also includes an input unit, such as a touch panel, a keyboard, or a mouse, to receive input from a user.

Similarly to the business sales promotion server 100, the information processing unit 50 includes a control unit provided with a CPU, RAM, and ROM. The information processing unit 50 also includes a communication unit such as Wireless Fidelity® or WiFi® enabled device complying with, for example, IEEE 802.11, or a wireless device complying with the IMT-2000 standard such as a third or fourth generation mobile communication system. The communication unit may be achieved through fixed LAN connection. The information processing unit 50 also includes a memory unit such as a hard disk or semiconductor memory to store data.

In the information processing unit 50, the control unit reads a predetermined program, cooperating with the communication unit, the output unit, the input unit, and the memory unit to achieve an electric appliance access module 53. The electric appliance access module 53 includes an electric appliance detection module 51 detecting the communicatively connected electric appliance 11 and a model related information determination module 52 determining the model related information of the detected electric appliance 10.

Similarly to the business sales promotion server 100 and the information processing unit 50, the electric appliance 11 includes a control unit provided with a CPU, RAM, and ROM. The electric appliance 11 also includes a communication unit such as WiFi® enabled device complying with, for example, IEEE 802.11, or a wireless device complying with the IMT-2000 standard such as a third or fourth generation mobile communication system. The communication unit may be achieved through fixed LAN connection. The electric appliance 11 may also include a data storage unit as a memory unit such as a hard disk or semiconductor memory to store data.

The electric appliance 11 may also include an output unit, such as a display unit, to output and display data and images that are controlled by the control unit. The electric appliance 11 also includes an input unit, such as a touch panel, a keyboard, or a mouse, to receive input from a user.

In the electric appliance 10, the control unit reads a predetermined program, cooperating with the communication unit, the output unit, the input unit, and the memory unit to achieve a response module 51.

The information processing units 50 as shown in FIG. 2 as many as the local networks are communicatively connected with the business sales promotion server 100. The sales representative terminal 20 as many as sales representatives are communicatively connected with the business sales promotion server 100.

### Model Related Information Determination Process

Before the sales recommendation process, the information processing unit 50 sends and receives a predetermined packet to the electric appliance 11 in order to execute the model related information determination process to determine the model related information of the electric appliance 10.

The model related information is information on the device types, such as the model name (model number) and the manufacturer name of the electric appliance 10. In the present process, the process to determine the types of electric appliances connected with a network by transmitting and receiving a packet may be used, as described in PLT 1. An example of the process to determine the model related information will be explained as disclosed herein.

The electric appliance detection module 51 of the information processing unit 50 transmits a detection packet to an electric appliance 11 (Step S20). The detection packet may be a packet transmitted from a command such as ping. The electric appliance 11 that has received a detection packet executes the detection response process by returning the IP address in response to the received packet (Step S21).

After the electric appliance 11 is detected, the model related information determination module 52 of the information processing unit 50 transmits a request packet to the detected electric appliance 11 (Step S22). The request packet is a packet for the information processing unit 50 to determine the model related information of the electric appliance 10.

For example, the request packet may be a command such as Address Resolution Protocol (hereinafter referred to as “ARP”), NETSTAT, Internet Control Message Protocol (hereinafter referred to as “ICMP”), or Simple Network Management Protocol (hereinafter referred to as “SNMP”), or may be a protocol complying with Universal Plug and Play (hereinafter referred to as “uPnP”) or Digital Living Network Alliance (hereinafter referred to as “DLNA”).

The electric appliance 11 transmits a response packet in response to the received request packet (Step S23). For example, a Media Access Control (hereinafter referred to as “MAC”) address is acquired as a response in response to an ARP command. The port numbers in use and the port occupancy of TCP/IP are identified by the command of NETSTAT.

Based on the response packet, the model related information determination module 52 of the information processing unit 50 determines the model related information of the electric appliance 11 that has transmitted the request packet (Step S24). The model related information is determined by scoring the response packet.

As one example, how to determine whether the model related information of the electric appliance 11 is the model name A or the model name B will be explained. The scores corresponding to the respective response packets to be received from each of the respective devices with the model names A and B are stored in the respective definition files for these model names. For example, in the case of the model name A, receiving the response packet (the TCP port 5000 is in use) for the request packet (NETSTAT) defines the score as “1” in the definition file, and other responses for a plurality of request packets (not only NETSTAT but also other response packets such as ARP) define the score as “0” in the definition file.

A response packet received from the electric appliance 11 is scored based on the respective definition files of the model names A and B. The model name of the definition file with higher score is determined as the model related information.

For example, in the case of the model name A, receiving the response packet (the TCP port 5000 is in use) for the request packet (NETSTAT) defines the score as “1,” and other responses define the score as “0.” On the other hand, in the case of the model name B, receiving the response packet (the TCP port 5000 is not in use) for the request packet (NETSTAT) defines the score as “1,” and other responses define the score as “0.”

In this case, when the response packet (the TCP port 5000 is not in use) is received from the electric appliance 10, the score is “0” as calculated based on the definition file of the model name A, and the score is “1” as calculated based on the definition file of the model name B. Therefore, the model name B is the model related information. In this case, the model name B is determined based on only the request packet NETSTAT. However, other request packets (e.g., ARP) are also scored in the same way, and the model related information is determined based on the total score for NETSTAT and ARP.

The above-mentioned definition file may be stored in not the information processing unit 50 but a server communicatively connected with the information processing unit 50. The information processing unit 50 may transmit a response packet that has received from the electric appliance 11 to the server to request the model related information from the server. In this case, the server determines the model related information upon request. The model related information determination module 52 of the information processing unit 50 acquires the model related information determined by the server and then executes the subsequent process.

The model related information determination module 52 preferably determines the model related information by scoring based on a plurality of request packets as described above. The request packet may simply be a command such ICMP or SNMP. Accordingly, the model related information determination module 52 may determine the model related information only based on a response packet to such a request packet by transmitting uPnP.

### Sales Recommendation Process

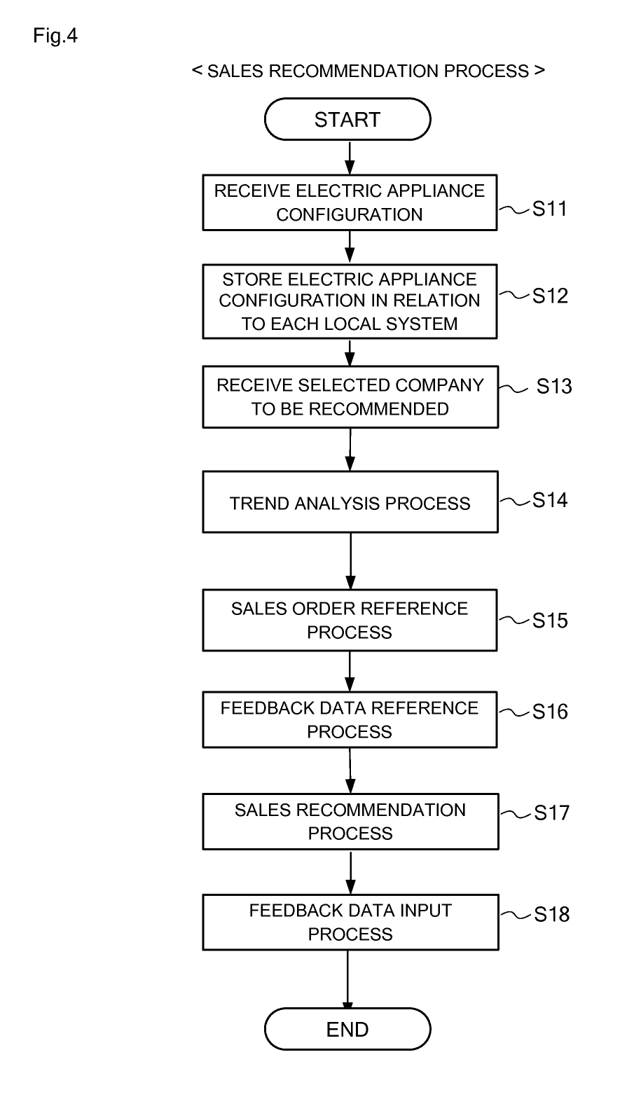

The sales recommendation process will be explained based on FIG. 4. After the model related information is determined, the information processing unit 50 transmits the electric appliance configuration including the determined model related information to the business sales promotion server 100. Specifically, the information processing unit 50 transmits the model related information (hereinafter referred to as “electric appliance configuration”) of all the electric appliances 11 in the local system 110 connected with the information processing unit 50 to the business sales promotion server 100.

At this time, the information processing unit 50 may also transmits the name of its own local system to the business sales promotion server 100.

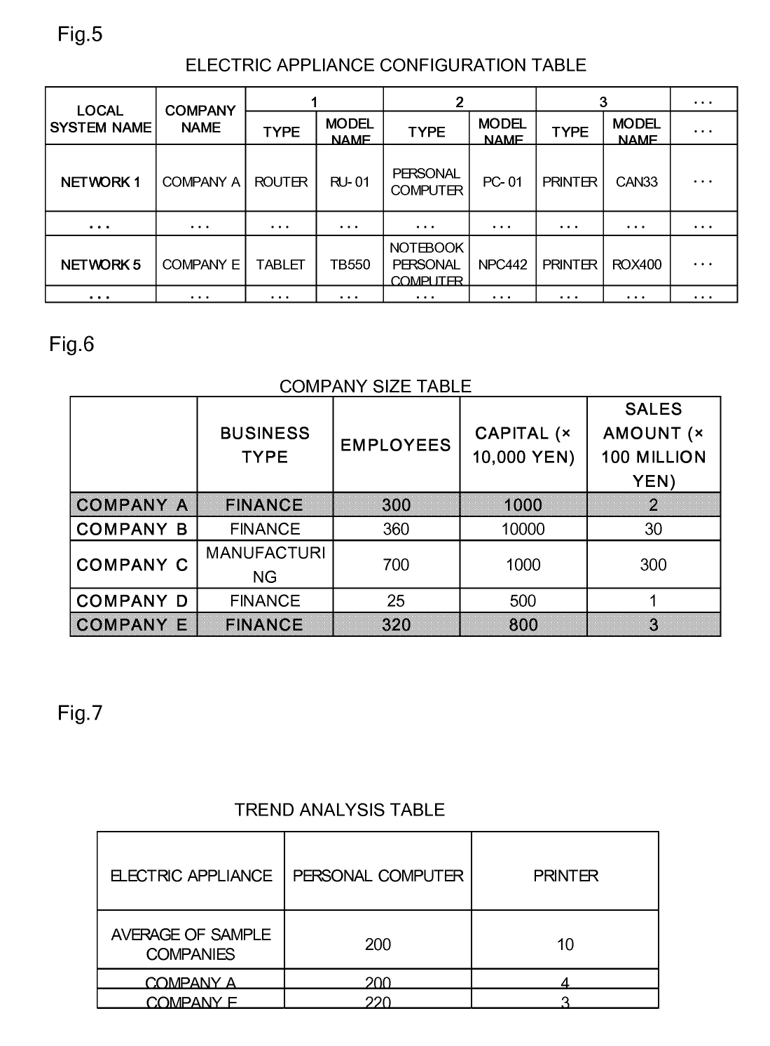

The business sales promotion server 100 receives the electric appliance configuration from the information processing unit 50 (Step S11), and the electric appliance configuration storage module 101 stores the received electric appliance configuration (Step S12). At this time, the electric appliance configuration may be stored in relation to each local system name, as shown in the electric appliance configuration table of FIG. 5. Specifically, for the local system with the name of NETWORK 1, the electric appliance configuration includes the router “RU-01,” the personal computer “PC-01,” the printer “CAN33,” and the like that are stored in relation to the name of NETWORK 1.

Then, the business sales promotion server 100 executes a selection receiving process for a company to be recommended (Step S13). This selection receipt process is a process to receive a selected company to be recommended for sales. For example, the business sales promotion server 100 may be accessed from the sales representative terminal 20 to receive a selected company input from a sales representative. Alternatively, in the case in which a sales representative is previously assigned to a company, and the user ID and the assigned company name of the sales representative are associatively stored, the business sales promotion server 100 may automatically select a company to which one sales representative is assigned when the sales representative logs on the business sales promotion server 100 with the sales representative's user ID,

Then, the trend analysis module 102 of the business sales promotion server 100 executes a trend analysis process (Step S14). The trend analysis process will be explained hereinafter.

Previously, the business sales promotion server 100 stores the company size table indicating the size of each company owning a local system as shown in FIG. 6. The company size table is a table in which the name of a company using a local system is associated with the type of business, the number of employees, the capital, the sales amount, and the like. Data in the company size table is input by an administrator and a user of the business sales promotion server 100. Associating this company size table with the electric appliance configuration table leads the size of a company to be associated with its electric appliance configuration.

The trend analysis module 102 references the company size table for the company selected in the step S13 and then extracts a company with the same type of business and the comparable size to the selected company. For example, in the case in which the company selected is COMPANY A, the trend analysis module 102 references the company size table and then extracts COMPANY E as a company with the same type of business and the comparable size to COMPANY A. The trend analysis module 102 extracts another company (not shown in FIG. 6) with the comparable size to COMPANY E, referencing the electric appliance configuration table, in order to calculate the average number of electric appliances 11 in a company (defined as a sample company) with the same type of business and the comparable size to COMPANY A.

The electric appliance configuration table of FIG. 5 includes the model related information (the types and the model names) of all the electric appliances connected with each local system. However, the electric appliance configuration table may include the number of each type of electric appliances 11 (e.g., 200 (personal computers) and 40 (printers)) belonging to one local system, in relation to the local system.

For example, the ratio of the number of printers to the number of personal computers in a sample company with the same type of business and the comparable size to COMPANY A. When COMPANY A has 200 personal computers and 4 printers, the printer introduction rate comes to 0.002 by calculation of 4 divided by 200. On the other hand, the average printer introduction rate of all sample companies like COMPANY E is calculated. For example, the average printer introduction rate is calculated to be 0.05.

In this case, the number of printers available for sales to COMPANY A is calculated by the following equation: Printers available for sales to COMPANY A=Personal computers in COMPANY A×Average printer introduction rate−Printers in the company A. Accordingly, the number of printers available for sales to COMPANY A comes to 6 by calculation of 200×0.05−4.

In order to perform trend analysis based on the printer introduction rate, the trend analysis table may be generated as shown in FIG. 7. Specifically, this table includes the respective numbers of personal computers and printers in a company (COMPANY A) to be recommended for sales, a sample company, and a company with the same business and the similar size to the company to be recommended for sales to calculate the number of printers available for sales.

The above example points to the printer introduction rate to the personal computer. However, the printer introduction rate is calculated for not limited to personal computers and, for example, may be calculated for professional software (e.g., documentation software and illustration software).

Then, the recommendation module 103 of the business sales promotion server 100 executes a sales order reference process (Step S15). Previously, a sales order is input by an administrator and the like of the business sales promotion server 100. The sales order is a customary order that can be a factor to allow the sale of an electric appliance 10. For example, the sales order may be a customary order to renew an electric appliance 11 in a certain industry and a certain company after a predetermined period elapses. The sales order may be a sales target order for sales promotion. For example, the sales target order is to sell an electric appliance 11 (projector) adapted to a predetermined electric appliance 11 (notebook personal computer) to a user who owns the predetermined electric appliance 10.

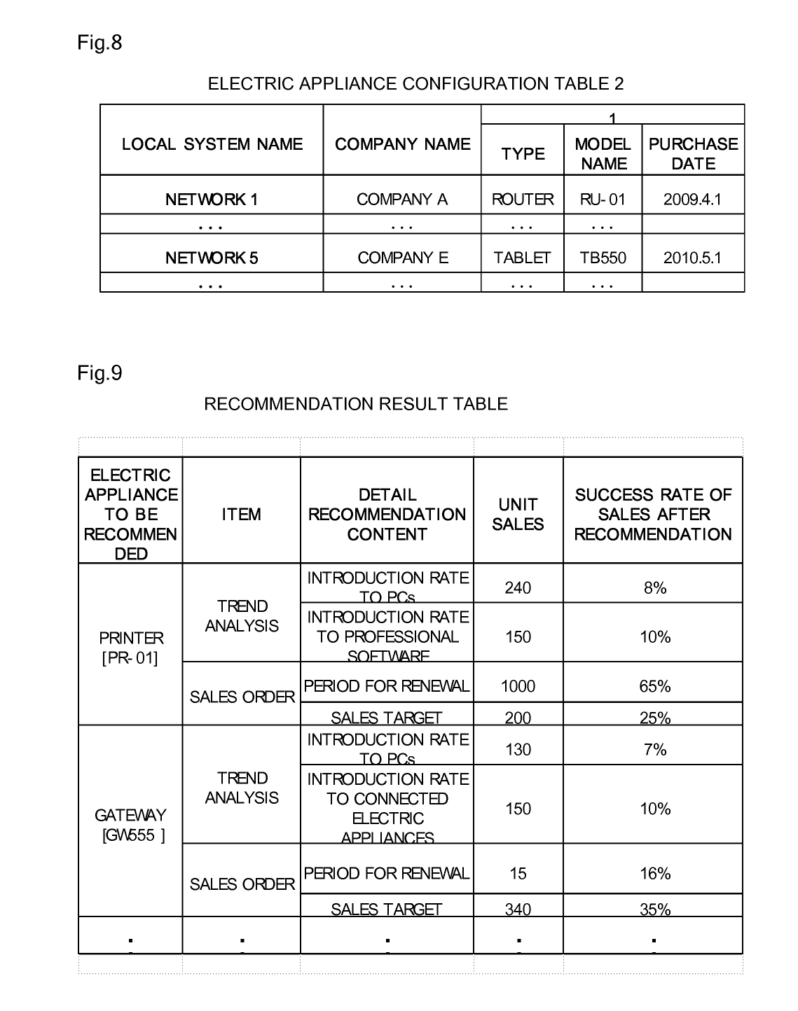

The recommendation module 103 of the business sales promotion server 100 checks if a sales order is applied to a recommended company, in this case, the company A. For example, if an order for renewal in a predetermined period is applied to the company A, the recommendation module 103 references the electric appliance configuration table 2 in which the purchase date of the electric appliance 11 is recorded as shown in FIG. 8, and then checks the presence of an electric appliance 11 required for renewal.

As another example, if a sales target order is applied, the recommendation module 103 references the electric appliances 11 owned by the company A, checks the presence of a target electric appliance 11 and then determines whether to sell the target electric appliance 10.

Then, the correction module 104 of the business sales promotion server 100 executes a feedback data reference process (Step S16). The feedback data reference process is a process to correct the display priority when the list of electric appliances recommended for sales is displayed on the sales representative terminal 20 as shown in FIG. 11. This will be explained with reference to the step S18.

Then, the recommendation module 103 executes a sales recommendation process (Step S17). The recommendation module 103 transmits and displays these data on the sales representative terminal 20 in order to recommend an electric appliance 11 determined to be recommended based on a trend analysis result and a sales order for a sales representative. As shown in FIG. 11, the sales representative terminal 20 displays the recommended electric appliances 10, specifically “Personal computer” and “Printer” on the recommended electric appliance for sales screen.

The screen image of the sales representative terminal 20 will be explained hereinafter. The sales representative terminal 20 is provided with a web browser and functions as a terminal that receives data from the business sales promotion server 100 and then displays the received data timely.

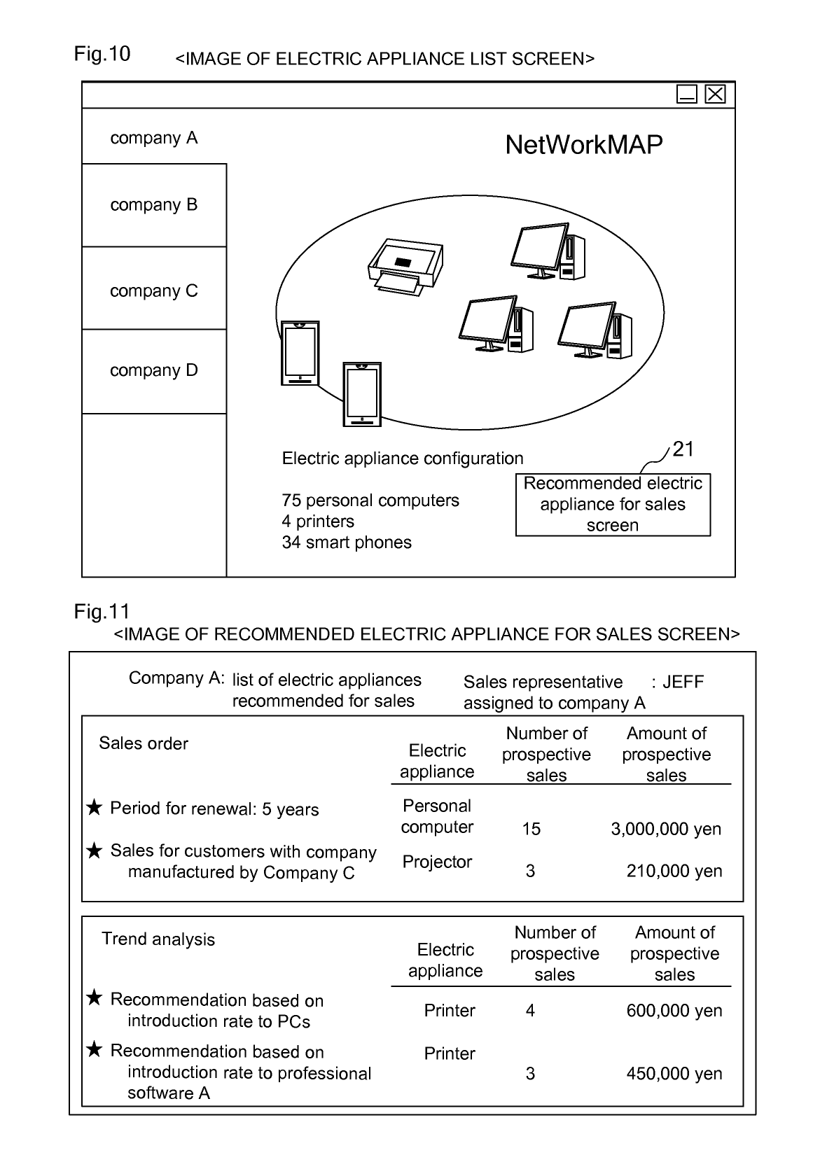

As shown in FIG. 10, the initial screen displayed on the sales representative terminal 20 is the network map of each company that shows the configuration of the connected electric appliances 10. This is a map that shows the list of the electric appliances 11 connected with each local system. The left of the window is provided with tabs to show and to select the network map of each company. For example, the screen shown in FIG. 10 displays the network map of Company A and the icon “Recommended electric appliance for sales” 21 that is to show the recommended electric appliance for sales screen shown in FIG. 11.

The recommended electric appliance for sales screen shows electric appliances recommended based on trend analysis and a sales order, showing together with the potential sales number and the prospective sales amount of the recommended electric appliances. The prospective sales amount can be calculated with respect to each electric appliance 10. In FIG. 11, the sales representative assigned to Company A logs on with the ID “JEFF” and then displays the recommendation contents for Company A.

The feedback data reference process will be explained with reference to the step S18. For example, the feedback data is the recommendation result table shown in FIG. 9. The recommendation result table includes the recommendation contents based on trend analysis for each electric appliance 11 to be recommended and based on a sales order, the number of electric appliances that has been sold by a sales representative as the recommendation contents instruct, and the success rate of sales.

For example, for Printer “PR-01,” the success rate of sales is 8% and the unit sales is 240 after recommendation in accordance with the recommendation content “INTRODUCTION RATE TO PCS” based on trend analysis.

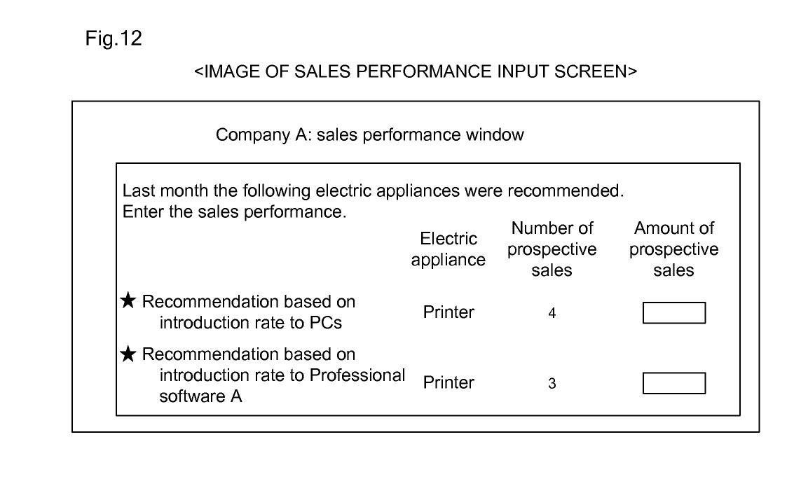

The number of sales is input from the sales performance input screen displayed on the sales representative terminal 20 as shown in FIG. 12. In other words, the sales representative inputs the number of sales from the sales representative terminal 20 in the step S18. Then, the success rate of sales after recommendation is calculated based on the number of sales and the number of times to display the recommended electric appliance on the sales representative terminal 20.

Then, the correction module 104 corrects the display priority for recommendation performed based on trend analysis and a sales order with reference to the recommendation result table in the feedback data reference process in the step S16, In the example of FIG. 11, the prospective sales amount in accordance with the recommendation based on the sales order (Period for renewal: 5 years) is 3,000,000 yen. On the other hand, the prospective sales amounts in accordance with trend analysis are 600,000 and 450,000 yen, which are smaller than that based on the sales order.

Accordingly, the correction module 103 references the recommendation result table to correct the display order in order to display the sales order (Period for renewal: 5 years) with the highest prospective sales amount first. Specifically, the recommendation contents with higher priority are displayed on the part that a sales representative can more easily view.

In this example, the display priority is determined based on the prospective sales amount. However, the display priority may be determined based on the unit sales and the amount of profits (calculated by subtracting the amount of purchases from the prospective sales amount).

In the example of FIG. 11, the type of the electric appliance 11 (such as a personal computer or a printer) is specified for recommendation. However, the model name and the type name (identification model name such as PR-01) of the electric appliance 11 may be specified for recommendation.

To achieve the functionality as described above, a computer (including a CPU, an information processor, or various terminals) reads and executes a predetermined program. For example, a program is provided recorded on a computer-readable storage medium such as a floppy disk, a CD (e.g., CD-ROM), or a DVD (e.g., DVD-ROM or DVD-RAM), or the like. In this case, a computer reads a program from the storage medium, forwards the program to internal or external storage to store the program therein, and executes the program. For example, the program may be previously recorded in a memory device (storage medium) such as a magnetic disk, an optical disk, or a magnetic optical disk, and then provided from the memory device to a computer through a communication line.

The embodiments of the present invention are described above, but the present invention is not limited thereto. The effects described in the embodiments of the present invention are merely listed as the most suitable effects produced from the present invention. The effects of the present invention are not limited to those described in the embodiments of the present invention.

### REFERENCE SIGNS LIST

1 recommendation system

3 public network

10 electric appliance

50 information processing unit

100 business sales promotion server

I claim:

1. A business sales promotion server communicatively connected with a sales representative terminal, comprising:
an electric appliance configuration storage module configured to store electric appliance configuration in relation to a local network, the electric appliance configuration including model related information acquired from an electric appliance connected with the local network; and
a recommendation module configured to output information on an electric appliance being lacking in one local network to the sales representative terminal based on the electric appliance configuration and then to recommend the sale of the electric appliance.

2. The business sales promotion server according to claim 1 further comprising a trend analysis module configured to analyze the average configuration ratio of one electric appliance to another electric appliance based on the electric appliance configuration, wherein
the recommendation module recommends the sale of an electric appliance and the unit sales thereof based on the configuration ratio analyzed by the trend analysis module.

3. The business sales promotion server according to claim 1, wherein the recommendation module recommends the sale of an electric appliance based on a sales order predetermining an electric appliance to be sold and the number thereof.

4. The business sales promotion server according to claim 1 further comprising a correction module configured to correct the recommendation from the recommendation module based on feedback data input from the sales representative terminal.

5. A sales promotion method executed by a server communicatively connected with a sales representative terminal, the method comprising the steps of:
storing electric appliance configuration in relation to a local network, the electric appliance configuration including model related information acquired from an electric appliance connected with the local network; and
outputting information on an electric appliance being lacking in one local network to the sales representative terminal based on the electric appliance configuration and then recommending the sale of the electric appliance.

6. A computer program product for use in a server communicatively connected with a sales representative terminal, comprising: a non-transitory computer usable medium having a set of instructions physically embodied therein, the set of instructions including computer readable code, which when executed by the server causes the server to:
store electric appliance configuration in relation to a local network, the electric appliance configuration including model related information acquired from an electric appliance connected with the local network; and
output information on an electric appliance being lacking in one local network to the sales representative terminal based on the electric appliance configuration and then recommend the sale of the electric appliance.
